(19) United States
(12) Patent Application Publication
(10) Pub. No.: US 2026/0025217 A1
(43) Pub. Date: Jan. 22, 2026

(54) CLOCK SYNCHRONIZATION FOR NETWORK END STATIONS

(71) Applicant: TEXAS INSTRUMENTS INCORPORATED, Dallas, TX (US)

(72) Inventors: Geet Govind MODI, Cupertino, CA (US); Sankar Prasad DEBNATH, Bengaluru (IN); Raghu GANESAN, Bengaluru (IN); Kalpesh Laxmanbhai RAJAI, Bengaluru (IN)

(21) Appl. No.: 18/789,296

(22) Filed: Jul. 30, 2024

Related U.S. Application Data
(60) Provisional application No. 63/672,942, filed on Jul. 18, 2024.

(51) Int. Cl. H04J 3/06

(52) U.S. Cl. CPC H04J 3/0638

(57) ABSTRACT

An apparatus includes: packet decoder circuitry; reference clock generator; control circuitry; and a media clock generator. A first terminal of the reference clock generator is coupled to a second terminal of the packet decoder circuitry. A first terminal of the control circuitry is coupled to a second terminal of the packet decoder circuitry. A second terminal of the control circuitry is coupled to a first terminal of the reference clock generator. A third terminal of the control circuitry is coupled to a second terminal of the reference clock generator. A first terminal of the media clock generator is coupled to the second terminal of the reference clock generator. A second terminal of the media clock generator is coupled to a fourth terminal of the control circuitry.

### CROSS-REFERENCE TO RELATED APPLICATIONS

The present application claims priority to U.S. Provisional Application No. 63/672,942, titled “CLOCK SYNCHRONIZATION FOR NETWORK END NODES”, Attorney Docket number T104492US01, filed on Jul. 18, 2024, which is hereby incorporated by reference in its entirety.

### BACKGROUND

Clock synchronization between network end stations ensures operations of the end stations are timed properly. For high-definition real-time networked audio applications (e.g., car road noise cancellation or audio playback), increased synchronization accuracy is desired. For instance, for car road noise cancellation, an example target time for a network to read the noise, generate a cancellation waveform, and play the cancellation waveform on speakers is approximately 3 ms to 4 ms. If clock synchronization and related latency is too high, some high-definition real-time networked audio applications are negatively affected.

### SUMMARY

In an example, an apparatus includes: packet decoder circuitry; a reference clock generator; control circuitry; and a media clock generator. The packet decoder circuitry has a first terminal and a second terminal. The reference clock generator has a first terminal and a second terminal. The first terminal of the reference clock generator is coupled to the second terminal of the packet decoder circuitry. The control circuitry has a first terminal, a second terminal, a third terminal, and a fourth terminal. The first terminal of the control circuitry is coupled to the second terminal of the packet decoder circuitry. The second terminal of the control circuitry is coupled to the first terminal of the reference clock generator. The third terminal of the control circuitry is coupled to the second terminal of the reference clock generator. The media clock generator has a first terminal and a second terminal. The first terminal of the media clock generator is coupled to the second terminal of the reference clock generator. The second terminal of the media clock generator is coupled to the fourth terminal of the control circuitry.

In another example, Ethernet physical (PHY) circuitry includes: packet decoder circuitry; a reference clock generator; control circuitry; and a media clock generator. The packet decoder circuitry has a first terminal and a second terminal. The reference clock generator has a first terminal and a second terminal. The first terminal of the reference clock generator is coupled to the second terminal of the packet decoder circuitry. The control circuitry has a first terminal, a second terminal, a third terminal, and a fourth terminal. The first terminal of the control circuitry is coupled to the second terminal of the packet decoder circuitry. The second terminal of the control circuitry is coupled to the first terminal of the reference clock generator. The third terminal of the control circuitry is coupled to the second terminal of the reference clock generator. The media clock generator has a first terminal and a second terminal. The first terminal of the media clock generator is coupled to the second terminal of the reference clock generator. The second terminal of the media clock generator is coupled to the fourth terminal of the control circuitry.

In yet another example, a method includes: receiving, by an Ethernet physical (PHY) layer, a clock reference packet; decoding, by the Ethernet PHY layer, a time stamp from the clock reference packet; adjusting, by the Ethernet PHY layer, a reference clock signal based on the time stamp; and generating, by the Ethernet PHY layer, a media clock based on the adjusted reference clock signal.

### BRIEF DESCRIPTION OF THE DRAWINGS

FIG. 1 is a diagram showing example end station circuitry.

FIGS. 2A and 2B are a block diagram showing an example system.

FIG. 3 is a diagram showing example end station circuitry.

FIG. 4 is a diagram showing example audio data encoding for an end station.

FIG. 5 is a diagram showing an example packet decoder.

FIG. 6 is a diagram showing example end station circuitry.

FIGS. 7A to AC are timing diagrams showing example clock synchronization.

FIG. 8 is a flowchart showing an example clock synchronization method.

FIGS. 9 and 10 are diagrams showing example PHY layer circuitry.

FIGS. 11 and 12 are flowcharts showing example PHY layer methods.

FIGS. 13 and 14 are diagrams showing example clock generator circuitry.

### DETAILED DESCRIPTION

The same reference numbers or other reference designators are used in the drawings to designate the same or similar features. Such features may be the same or similar either by function and/or structure.

In the described examples, network end stations use hardware to periodically generate a clock reference packet with a time stamp and/or decode a time stamp from a received clock reference packet. As used herein, a “clock reference packet” refers to a packet that includes a time stamp or other time indicator. In some examples, a clock reference packet may be a Clock Reference Format (CRF) packet with time stamps defined by Institute of Electrical and Electronics Engineers (IEEE) 1722. As used herein, a “network end station” or just “end station” refers to a streaming data producer or a streaming data consumer. A streaming data producer operates to produce data or data packets/records synchronized with a time stamp. A streaming data consumer operates to consume the data or data packets/records synchronized with the time stamp. Such time stamps are used by an end station to synchronize its local reference clock signal with the time stamps. A synchronized local reference clock signal may be used to generate media clock signals or other clock signals for use by an end station to produce or consume streaming data. In some examples, media clock signals are used to encode, decode, and/or transfer audio or video data. In some examples, the hardware to periodically generate a clock reference packet with a time stamp and/or parse a time stamp from a received clock reference packet is part of an Ethernet physical (PHY) layer. Such hardware expedites synchronization of the local reference clock signal with time stamps. In addition, hardware may expedite generation of media clocks or other clock signals from the synchronized local reference clock signal.

In some examples, time synchronization defined by IEEE 802.1AS is used. In such examples, a common audio clock to source the packets over an Inter-IC Sound (I2S) interface is generated based on the time stamps provided in Clock Reference Format (CRF) packets defined by IEEE 1722. In some examples, the CRF packets include time stamps based on IEEE 802.1AS synchronization. The end stations decode, parse, or otherwise extract time stamps from these CRF packets. In some examples, the decoded, parsed, or extracted time stamps are used by an end station to generate media clocks synchronized with the time stamps. As used herein, “media clocks” refer to a family of clock signals with related edges and/or phase. Example media clocks include an Audio Frame Sync Clock (FSYNC), a bit clock (BCLK), and a CODEC clock. In some examples, FSYNC and BCLK and/or other media clocks are used to produce and/or consume audio packets (e.g., to produce streaming audio on one end station, and consume the streaming audio by another end station).

In some examples, end stations use the Audio Video Transport Protocol (AVTP) specified by IEEE 1722 to transport audio, video, and control data on a Time-Sensitive Networking (TSN) capable network. In some examples, AVTP on TSN capable networks support generalized Precision Time Protocol (gPTP), Stream Reservation Protocol (SRP), and Forwarding and Queing Enhancements for Time-Sensitive Streams (FQTSS). Example AVTP methods transport data and timing information so that audio, video, or control content sent by a “talker” end station can be reproduced on listener end stations. The audio, video, or control content may be organized into streaming data with frames, where some frames may be processed at the same time. In some examples, AVTP streams are sent from a talker end station and are received by one or more listener end stations. In some examples, AVTP stream data is carried on an underlying MAC layer such as IEEE 802.3 or IEEE 802.11. It is also possible to encapsulate AVTP in internet protocol (IP) data. The end stations that send or receive audio, video, or time-sensitive control data support the TSN services provided by gPTP, SRP, and FQTSS. AVTP relies on these services being available to interoperate. AVTP end stations that only support data formats that are not time-sensitive may omit TSN services. AVTP makes use of gPTP to provide a network-wide time base that can be used to convey timing information from a talker end station to a listener end station. AVTP makes use of SRP and FQTSS to provide reliable network delivery with bounded network latency for transporting data from a talker end station to one or more listener end stations. AVTP data may be sent from a talker end station to a listener end station either directly or may be forwarded by a TSN bridge to a listener end station.

AVTP defines a presentation time to achieve timing synchronization between a talker end station and listener end station. The presentation time represents in nanoseconds the gPTP time when the data contained in the AVTPDU is to be available to a listener end station. The AVTP presentation time is used as a reference to synchronize any necessary media clocks and to determine when the payload of a stream is to be presented to the time-sensitive application. Media clocks vary with audio/video types therefore the exact usage of the AVTP presentation time is media format dependent. AVTPDUs are subject to variable transit times between a talker end station and a listener end station. The AVTP presentation time is used to account for this variability and facilitate synchronization of each AVTPDU's payload data at listener end stations.

Compared to software options to periodically generate a clock reference packet (e.g., a CRF packet or other packet with timing information) with a time stamp and/or decode a time stamp from a received clock reference packet, the hardware solutions described herein reduce the latency of synchronizing the local reference clock with a time stamp, improves the accuracy of such synchronization, and reduces the latency of generating media clocks from the synchronized local reference clock. Such reduction in latency may facilitate road noise cancellation or other applications where the speed and accuracy of clock synchronization and related media clock generation is important.

In some examples, an end station includes a media access (MAC) layer and an Ethernet physical (PHY) layer. In some examples, the MAC layer is based on IEEE 802.3 or IEEE 802.11. In such examples, circuitry of the MAC layer (also referred to herein as MAC circuitry) perform operations including, but not limited to, generic Precision Time Protocol (gPTP) management and audio video bridging (AVB) management. Circuitry of the Ethernet PHY layer (also referred to herein as Ethernet PHY or Ethernet PHY circuitry) may perform operations including, but not limited to, generating an outgoing clock reference packet with a time stamp and decoding a time stamp from an incoming clock reference packet.

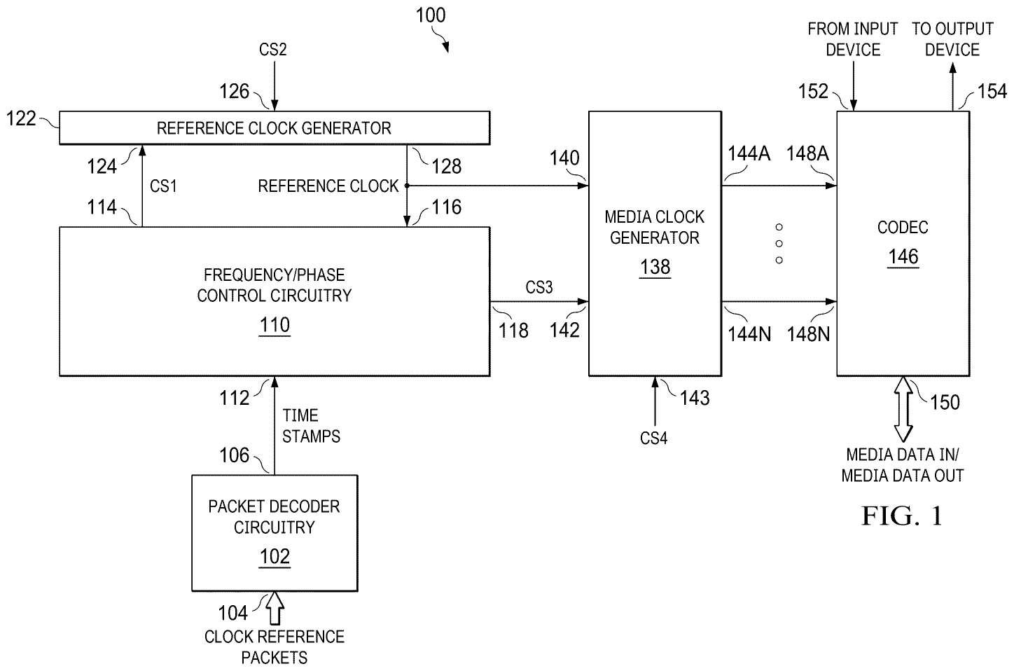

FIG. 1 is a diagram showing example end station circuitry 100. The end station circuitry 100 includes packet decoder circuitry 102, frequency/phase control circuitry 110, a reference clock generator 122, a media clock generator 138, and a coder/decoder (CODEC) 146. In some examples, the packet decoder circuitry 102, the frequency/phase control circuitry 110, the reference clock generator 122, and the media clock generator 138 are components of an Ethernet PHY. Besides the end station circuitry 100, an end station may also include other circuitry to perform talker end station operations (e.g., generate talker data, format the talker data, and transmit the talker data and related timing control data to a network interface, etc.) and/or listener end station operations (e.g., receive talker data from a network interface, decode the talker data and related timing control data, consume/display the decoded talker data based on the timing control data, etc.).

The packet decoder circuitry 102 has a first terminal 104 and a second terminal 106. The frequency/phase control circuitry 110 has a first terminal 112, a second terminal 114, a third terminal 116, and a fourth terminal 118. The reference clock generator 122 has a first terminal 124, a second terminal 126, and a third terminal 128. The media clock generator 138 has a first terminal 140, a second terminal 142, a third terminal 143, and fourth terminals 144A to 144N. The CODEC 146 has first terminals 148A to 148N, a second terminal 150, a third terminal 152, and a fourth terminal 154.

In the example of FIG. 1, the first terminal 104 of the packet decoder circuitry receives clock reference packets. The second terminal 106 of the packet decoder circuitry 102 is coupled to the first terminal 112 of the frequency/phase control circuitry 110.

The second terminal 114 of the frequency/phase control circuitry 110 is coupled to the first terminal 124 of the reference clock generator 122 and provides control settings CS1. The control settings CS1 may include frequency and/or phase settings to adjust the frequency and/or phase of the reference clock responsive to IEEE 1722 CRF time stamps, resulting in a synchronized reference clock signal. The second terminal 126 of the reference clock generator 122 may be coupled to a host interface and receives control settings CS2. In some examples, the control settings CS2 includes frequency and/or phase settings to adjust the reference clock without IEEE 1722 CRF time stamps. The control settings CS2 are received, for example, from a host via a host interface such as a management data input/output (MDIO) interface. The third terminal 128 of the reference clock generator 122 is coupled to the third terminal 116 of the frequency/phase control circuitry 110 and the first terminal 140 of the media clock generator 138. The third terminal 128 provides a synchronized reference clock signal based on the control settings CS1 or the control settings CS2. The fourth terminal 118 of the frequency/phase control circuitry 110 is coupled to the second terminal 142 of the media clock generator 138 and provides control settings CS3. For example, the control settings CS3 includes frequency and/or phase settings for the media clock generator 138 responsive to IEEE 1722 CRF time stamps and/or the synchronized reference clock signal.

The third terminal 143 of the media clock generator 138 may be coupled to a host interface and receives control settings CS4. In some examples, the control settings CS4 includes frequency and/or phase settings to adjust the media clocks without IEEE 1722 CRF time stamps. The control settings CS4 are received, for example, from a host via a host interface such as an MDIO interface. The fourth terminals 144A to 144N of the media clock generator 138 are coupled to the first terminals 148A to 148N of the CODEC 146. The second terminal 150 of the CODEC 146 receives or outputs media data. The third terminal 152 of the CODEC 146 may be coupled to an input device (not shown). The fourth terminal 154 of the CODEC 146 may be coupled to an output device (not shown).

In some examples, the packet decoder circuitry 102 operates to: receive a clock reference packet (e.g., an IEEE 1722 CRF packet) at the first terminal 104; decode a time stamp from the clock reference packet; and provide the time stamp at the second terminal 106. The frequency/phase control circuitry 110 operates to: receive time stamps at the first terminal 112; and provide the control settings CS1 at the second terminal 114 responsive to the time stamps.

The reference clock generator 122 operates to: receive the control settings CS1 at the first terminal 124; and provide a reference clock signal at the third terminal 128 responsive to the control settings CS1. In some examples, the control settings CS1 include frequency and/or phase settings to adjust frequency and/or phase of the reference clock signal responsive to time stamps decoded from clock reference packets and/or other control parameters. In other words, the frequency/phase control circuitry 110 may control the reference clock signal to be synchronized with the time stamps. In some examples, the reference clock generator 122 operates to: receive the control settings CS2 at the second terminal 126; and provide a reference clock signal at the third terminal 128 responsive to the control settings CS2. In some examples, the control settings CS2 include frequency and/or phase settings to adjust frequency and/or phase of the reference clock signal responsive to host control settings without time stamps from decoded clock reference packets.

The frequency/phase control circuitry 110 may also operate to: receive a synchronized reference clock signal at the third terminal 116; and provide the control settings CS3 at the fourth terminal 118 responsive to previously received time stamps and/or the synchronized reference clock signal. The control settings CS3 include frequency and/or phase settings for the media clock generator 138. Over time, the frequency/phase control circuitry 110 may adjust the control settings CS3 as needed to account for phase offset between a previously synchronized reference clock signal and time stamps, which are periodically received.

The media clock generator 138 operates to: receive the synchronized reference clock signal at the first terminal 140 (e.g., synchronized based on the control settings CS1, which may be based on time stamps decoded from a clock reference packet); receive the control settings CS3 at the second terminal 142; and provide media clock signals at the fourth terminals 144A to 144N responsive to the reference clock signal and the control settings CS3. In some examples, the media clock generator 138 operates to: receive the control settings CS4 at the third terminal 143; and provide media clock signals at the fourth terminals 144A and 144N responsive to the control settings CS4.

In different examples, the clock signals at the fourth terminals 144A to 144N have the same frequency or different frequencies. In some examples, the clock signals at the fourth terminals 144A to 144N include media clock signals used to encode audio data, video data, or other media data to be transferred to another end station. As another example, the clock signals at the fourth terminals 144A to 144N include media clock signals used to decode audio data or other media data received from another end station.

In some examples, the CODEC 146 operates to: receive input data from an input device at the third terminal 152; receive media clock signals at the first terminals 148A to 148N; encode the input data as an outgoing media stream based on the media clock signals; and provide the outgoing media stream at the second terminal 150. In some examples, the input device is a microphone or other audio data source. The CODEC 146 may also operate to: receive a media stream at the second terminal 150; receive media clock signals at the first terminals 148A to 148N; decode the media steam to determine output data based on the media clock signals; and provide the output data at the fourth terminal 154. The output data is provided to an output device, which may be a speaker or other output device.

In some examples, the packet decoder circuitry 102, the frequency/phase control circuitry 110, the reference clock generator 122, and the media clock generator 138 are components of Ethernet PHY layer circuitry. In some examples, the media stream is an audio data stream formatted based on IEEE 802.3 or IEEE 802.11.

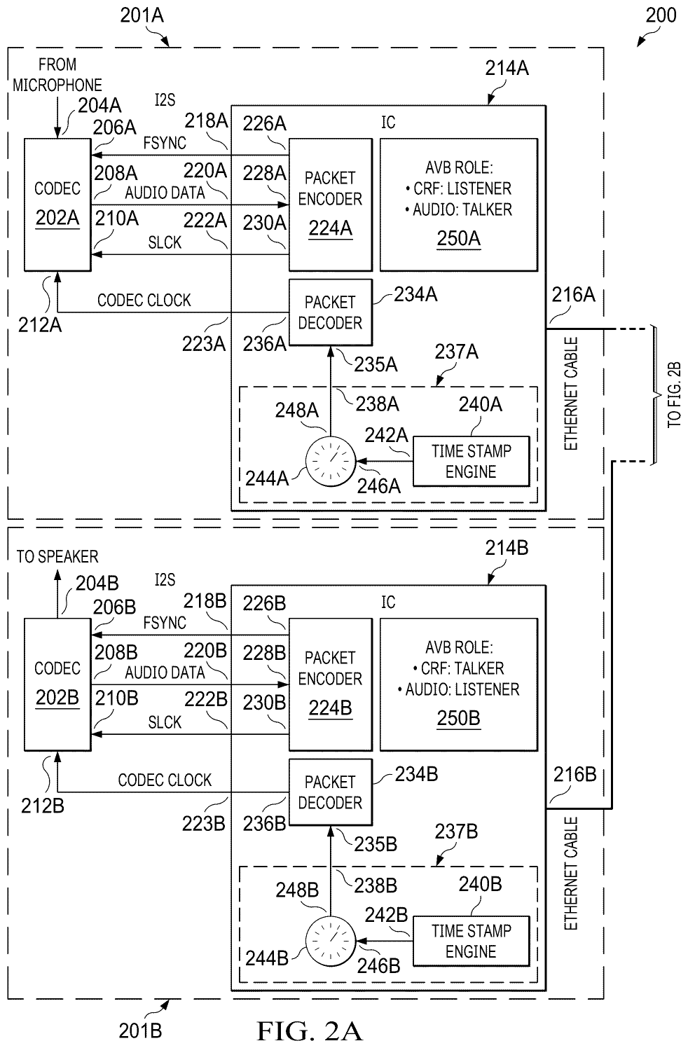

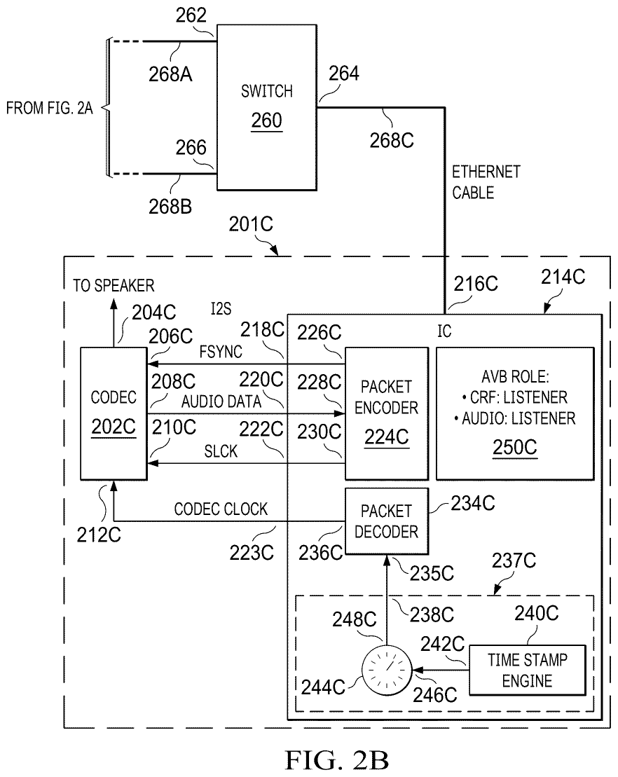

FIGS. 2A and 2B are a block diagram showing an example system 200. As shown, the system 200 includes end stations 201A, 201B, and 201C coupled together via a switch 260 and cables 268A, 268B, and 268C. In some examples, the end stations 201A, 201B, and 201C, the switch 260, and the cables 268A, 268B, and 268C are components of a vehicle or other enclosed audio system space. The end station 201A includes end station circuitry 214A and CODEC 202A. The CODEC 202A is an example of the CODEC 146 in FIG. 1 and other components of the end station circuitry 100 are included in the end station circuitry 214A. The end station 201B includes end station circuitry 214B and CODEC 202B. The CODEC 202B is an example of the CODEC 146 in FIG. 1 and other components of the end station circuitry 100 are included in the end station circuitry 214B. The end station 201C includes end station circuitry 214C and CODEC 202C. The CODEC 202C is an example of the CODEC 146 in FIG. 1 and other components of the end station circuitry 100 are included in the end station circuitry 214C. In some examples, the end station circuitry 214A, the end station circuitry 214B, and the end station circuitry 214C include integrated circuit (IC) components. An example IC includes system-on-a-chip (SoC) circuitry and PHY layer circuitry. In some examples, the end station circuitries 214A, 214B, and 214C perform data transfers based on IEEE 802.3 or IEEE 802.11. In some examples, the cables 268A, 268B, and 268C are Ethernet cables.

In some examples, the end station circuitry 214A includes a packet encoder 224A, a packet decoder 234A, clock generator circuitry 237A, and a role controller 250A. In some examples, the packet encoder 224A and the role controller 250A are MAC layer components (e.g., software executed by an SoC processor). In some examples, the clock generator circuitry 237A and the packet decoder 234A are Ethernet PHY components and include the end station circuitry 100 of FIG. 1 except the CODEC 146. The packet decoder 234A is an example of the packet decoder circuitry 102 in FIG. 1. In some examples, the clock generator circuitry 237A includes a time stamp engine 240A and a clock generator 244A. In some examples, the role controller 250A defines audio video bridging (AVB) roles for the end station 201A. In the example of FIGS. 2A and 2B, the end station 201A has the roles of clock reference format (CRF) listener and audio talker based on predetermined or preselected settings of the role controller 250A. In some examples, the CODEC 202A is an audio codec configured to encode audio data from a microphone (not shown) for transmission to the end stations 201B and 201C.

In some examples, the end station circuitry 214B includes a packet encoder 224B, a packet decoder 234B, clock generator circuitry 237B, and role controller 250B. In some examples, the packet encoder 224B and the role controller 250B are MAC layer components (e.g., software executed by an SoC processor). In some examples, the clock generator circuitry 237B and the packet decoder 234B are Ethernet PHY components and include the end station circuitry 100 of FIG. 1 except the CODEC 146. The packet decoder 234B is an example of the packet decoder circuitry 102 in FIG. 1. In some examples, the clock generator circuitry 237B includes a time stamp engine 240B and a clock generator 244B. In some examples, the role controller 250B defines AVB roles for the end station 201B. In the example of FIGS. 2A and 2B, the end station 201B has the roles of CRF talker and audio listener based on predetermined or preselected settings of the role controller 250B. In some examples, the CODEC 202B is an audio codec configured to decode audio data and provide the decoded audio data to a speaker (not shown).

In some examples, the end station circuitry 214C includes a packet encoder 224C, a packet decoder 234C, clock generator circuitry 237C, and role controller 250C. In some examples, the packet encoder 224C and the role controller 250C are MAC layer components (e.g., software executed by an SoC processor). In some examples, the clock generator circuitry 237C and the packet decoder 234C are Ethernet PHY components and include the end station circuitry 100 of FIG. 1 except the CODEC 146. The packet decoder 234C is an example of the packet decoder circuitry 102 in FIG. 1. In some examples, the clock generator circuitry 237C includes a time stamp engine 240C and a clock generator 244C. In some examples, the role controller 250C defines AVB roles for the end station 201C. In the example of FIGS. 2A and 2B, the end station 201C has the roles of CRF talker and audio listener based on predetermined or preselected settings of the role controller 250C. In some examples, the CODEC 202C is an audio codec configured to decode audio data and provide the decoded audio data to a speaker (not shown).

In the example of FIGS. 2A and 2B, the CODEC 202A has a first terminal 204A, a second terminal 206A, a third terminal 208A, a fourth terminal 210A, and a fifth terminal 212A. The end station circuitry 214A has a first terminal 216A, a second terminal 218A, a third terminal 220A, a fourth terminal 222A, and a fifth terminal 223A. The packet encoder 224A has a first terminal 226A, a second terminal 228A, and a third terminal 230A. The packet decoder 234A has a first terminal 235A and a second terminal 236A. The clock generator circuitry 237A has a terminal 238A. The time stamp engine 240A has a terminal 242A. The clock generator 244A has a first terminal 246A and a second terminal 248A.

As shown, the CODEC 202B has a first terminal 204B, a second terminal 206B, a third terminal 208B, a fourth terminal 210B, and a fifth terminal 212B. The end station circuitry 214B has a first terminal 216B, a second terminal 218B, a third terminal 220B, a fourth terminal 222B, and a fifth terminal 223B. The packet encoder 224B has a first terminal 226B, a second terminal 228B, and a third terminal 230B. The packet decoder 234B has a first terminal 235B and a second terminal 236B. The clock generator circuitry 237B has a terminal 238B. The time stamp engine 240B has a terminal 242B. The clock generator 244B has a first terminal 246B and a second terminal 248B.

The CODEC 202C has a first terminal 204C, a second terminal 2060, a third terminal 208C, a fourth terminal 210C, and a fifth terminal 212C. The end station circuitry 214C has a first terminal 216C, a second terminal 218C, a third terminal 220C, a fourth terminal 222C, and a fifth terminal 223C. The packet encoder 224C has a first terminal 226C, a second terminal 228C, and a third terminal 230C. The packet decoder 234C has a first terminal 235C and a second terminal 236C. The clock generator circuitry 237C has a terminal 238C. The time stamp engine 240C has a terminal 242C. The clock generator 244C has a first terminal 246C and a second terminal 248C.

As shown, the first terminal 262 of the switch 260 is coupled to the first terminal 216A of the end station circuitry 214A. The second terminal 218A of the end station circuitry 214A is coupled to the second terminal 206A of the CODEC 202A. The third terminal 220A of the end station circuitry 214A is coupled to the third terminal 208A of the CODEC 202A. The fourth terminal 222A of the end station circuitry 214A is coupled to the fourth terminal 210A of the CODEC 202A. The fifth terminal 223A of the end station circuitry 214A is coupled to the fifth terminal 212A of the CODEC 202A. The first terminal 204A of the CODEC 202A is coupled to a microphone (not shown) or other input device.

The first terminal 226A of the packet encoder 224A is coupled to the second terminal 218A of the end station circuitry 214A. The second terminal 228A of the packet encoder 224A is coupled to the third terminal 220A of the end station circuitry 214A. The third terminal 230A of the packet encoder 224A is coupled to the fourth terminal 222A of the end station circuitry 214A. The second terminal 236A of the packet decoder 234A is coupled to the fifth terminal 223A of the end station circuitry 214A. The first terminal 235A of the packet decoder 234A is coupled to the terminal 238A of the clock generator circuitry 237A. The terminal 242A of the time stamp engine 240A is coupled to the first terminal 246A of the clock generator 244A. The second terminal 248A of the clock generator 244A is coupled to the terminal 238A of the clock generator circuitry 237A.

The second terminal 264 of the switch 260 is coupled to the first terminal 216B of the end station circuitry 214B. The second terminal 218B of the end station circuitry 214B is coupled to the second terminal 206B of the CODEC 202B. The third terminal 220B of the end station circuitry 214B is coupled to the third terminal 208B of the CODEC 202B. The fourth terminal 222B of the end station circuitry 214B is coupled to the fourth terminal 210B of the CODEC 202B. The fifth terminal 223B of the end station circuitry 214B is coupled to the fifth terminal 212B of the CODEC 202B. The first terminal 204B of the CODEC 202B is coupled to a microphone (not shown) or other input device.

The first terminal 226B of the packet encoder 224B is coupled to the second terminal 218B of the end station circuitry 214B. The second terminal 228B of the packet encoder 224B is coupled to the third terminal 220B of the end station circuitry 214B. The third terminal 230B of the packet encoder 224B is coupled to the fourth terminal 222B of the end station circuitry 214B. The second terminal 236B of the packet decoder 234B is coupled to the fifth terminal 223B of the end station circuitry 214B. The first terminal 235B of the packet decoder 234B is coupled to the terminal 238B of the clock generator circuitry 237B. The terminal 242B of the time stamp engine 240B is coupled to the first terminal 246B of the clock generator 244B. The second terminal 248B of the clock generator 244B is coupled to the terminal 238B of the clock generator circuitry 237B.

The third terminal 266 of the switch 260 is coupled to the first terminal 216C of the end station circuitry 214C. The second terminal 218C of the end station circuitry 214C is coupled to the second terminal 206C of the CODEC 202C. The third terminal 220C of the end station circuitry 214C is coupled to the third terminal 208C of the CODEC 202C. The fourth terminal 222C of the end station circuitry 214C is coupled to the fourth terminal 210C of the CODEC 202C. The fifth terminal 223C of the end station circuitry 214C is coupled to the fifth terminal 212C of the CODEC 202C. The first terminal 204C of the CODEC 202C is coupled to a microphone (not shown) or other input device.

The first terminal 226C of the packet encoder 224C is coupled to the second terminal 218C of the end station circuitry 214C. The second terminal 228C of the packet encoder 224C is coupled to the third terminal 220C of the end station circuitry 214C. The third terminal 230C of the packet encoder 224C is coupled to the fourth terminal 222C of the end station circuitry 214C. The second terminal 236C of the packet decoder 234C is coupled to the fifth terminal 223C of the end station circuitry 214C. The first terminal 235C of the packet decoder 234C is coupled to the terminal 238C of the clock generator circuitry 237C. The terminal 242C of the time stamp engine 240C is coupled to the first terminal 246C of the clock generator 244C. The second terminal 248C of the clock generator 244C is coupled to the terminal 238C of the clock generator circuitry 237C.

In the example of FIGS. 2A and 2B, the end station 201A operates to receive and encode media data (e.g., audio data from a microphone or other media data) using the CODEC 202A and the end station circuitry 214A. The encoded media data is transferred to the end stations 201B and 201C via the switch 260 and the cables 268A to 268C. The end station 201B operates to receive and decode the encoded media data using the end station circuitry 214B and the CODEC 202B. The decoded media data is provided from the CODEC 202B to a speaker or other output device. The end station 201C operates to receive and decode the encoded media data using the end station circuitry 214C and the CODEC 202C. The decoded media data is provided from the CODEC 202C to a speaker or other output device.

In the example of FIGS. 2A and 2B, clock synchronization of the end stations 201A, 201B, and 201C is provided by the clock generator circuitries 237A, 237B, and 237C. To expedite clock synchronization (e.g., synchronization within 5 to 10 media clock cycles). the clock generator circuitries 237A, 237B, and 237C use hardware to decode a time stamp from a received clock reference packet, determine a phase offset between the time stamp or time indicator (e.g., from a CFR packet time stamp) and a reference clock signal, and generate a media clock signal responsive to the phase offset. In some examples, the end station circuitry 214A, the end station circuitry 214B, and the end station circuitry 214C includes an Ethernet PHY. The Ethernet PHY of the end station circuitry 214A includes the clock generator circuitry 237A. The Ethernet PHY of the end station circuitry 214B includes the clock generator circuitry 237B. The Ethernet PHY of the end station circuitry 214C includes the clock generator circuitry 237C. Media clock signals may be used, for example, to perform CODEC and/or other operations.

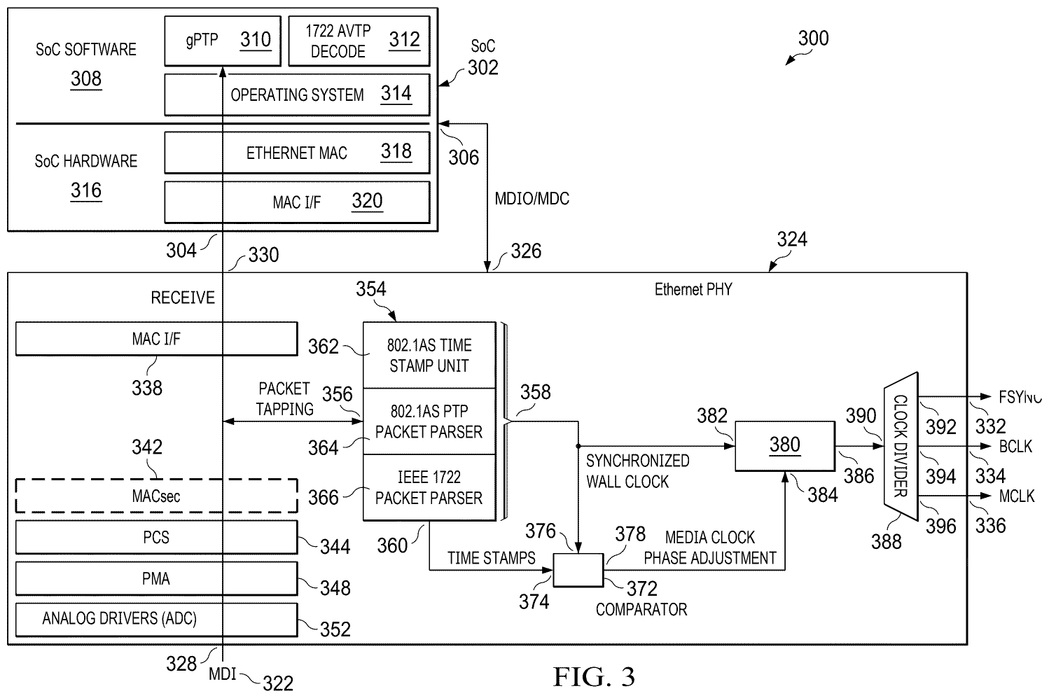

FIG. 3 is a diagram showing an example end station circuitry 300. The end station circuitry 300 may be included in the end station circuitries 214A, 214B, and 214C in FIG. 1. As shown, the end station circuitry 300 includes a SoC 302 and an Ethernet PHY 324. In the example of FIG. 3, a medium dependent interface (MDI) 322 connects the SoC 302 to the Ethernet PHY 324. The SoC 302 has a first terminal 304 and a second terminal 306. In the example of FIG. 3, the SoC 302 includes SoC software 308 and SoC hardware 316. The SoC software 308 includes a timing protocol 310, a packet decoder 312, and an operating system 314. In some examples, the timing protocol 310 is generic Precision Time Protocol (gPTP), where gPTP is defined by the IEEE 802.1AS-2011 standard. In some examples, the packet decoder 312 is based on IEEE 1722 audio video transport protocol (AVTP). The SoC hardware 316 includes Ethernet MAC circuitry 318 and MAC interface (I/F) circuitry 320 to perform, for example, MAC operations defined in IEEE 802.3 and/or IEEE 802.11.

The Ethernet PHY 324 has a first terminal 326, a second terminal 328, a third terminal 330, a fourth terminal 332, a fifth terminal 334, and a sixth terminal 336. In the example of FIG. 3, the Ethernet PHY 324 includes MAC interface (I/F) circuitry 338, a MAC security (MACsec) interface 342, physical coding sublayer (PCS) circuitry 344, physical medium attachment (PMA) circuitry 348, and analog drivers 352. The Ethernet PHY 324 also includes a time stamp engine 354, a comparator 372, a clock generator 380, and a clock divider 388. Together, the clock generator 380 and the clock divider 388 operate as a media clock generator (e.g., the media clock generator 138 in FIG. 1). The time stamp engine 354 is an example of the time stamp engine 240A, 240B, or 240C in FIGS. 2A and 2B. In some examples, the time stamp engine 354 includes an IEEE 802.1AS time stamp unit 362, an IEEE 802.1AS packet parser 364, and an IEEE 1722 packet parser 366. The time stamp engine 354 may also include time stamp storage and CRF storage such as FIFO registers and/or buffers. The clock generator 380 is an example of the clock generator 244A, 244B, or 244C in FIGS. 2A and 2B.

In the example of FIG. 3, the time stamp engine 354 has a first terminal 356, a second terminal 358, and a third terminal 360. The comparator 372 has a first terminal 374, a second terminal 376, and third terminal 378. The clock generator 380 has a first terminal 382, a second terminal 384, and a third terminal 386. The clock divider 388 has a first terminal 390, a second terminal 392, a third terminal 394, and a fourth terminal 396.

The first terminal 326 of the Ethernet PHY 324 is coupled to the second terminal 306 of the SoC 302. The second terminal 328 of the Ethernet PHY 324 may be coupled to a cable (e.g., one of the cables 268A, 268B, or 268C in FIGS. 2A and 2B). The third terminal 330 of the Ethernet PHY 324 is coupled to the first terminal 304 of the SoC 302. The fourth terminal 332, the fifth terminal 334, and the sixth terminal 336 of the Ethernet PHY 324 may be coupled to respective terminals of a CODEC (e.g., the CODECs 202A, 202B, and 202C in FIGS. 2A and 2B). In some examples, the fourth terminal 332 of the Ethernet PHY 324 is coupled to the second terminal 206A of the CODEC 202A, the fifth terminal 334 of the Ethernet PHY 324 is coupled to the fourth terminal 210A of the CODEC 202A, and the sixth terminal 336 of the Ethernet PHY 324 is coupled to the fifth terminal 212A of the CODEC 202A. In other examples, the fourth terminal 332 of the Ethernet PHY 324 is coupled to the second terminal 206B of the CODEC 202B, the fifth terminal 334 of the Ethernet PHY 324 is coupled to the fourth terminal 210B of the CODEC 202B, and the sixth terminal 336 of the Ethernet PHY 324 is coupled to the fifth terminal 212B of the CODEC 202B. In other examples, the fourth terminal 332 of the Ethernet PHY 324 may be coupled to the second terminal 206C of the CODEC 202C, the fifth terminal 334 of the Ethernet PHY 324 may be coupled to the fourth terminal 210C of the CODEC 202C, and the sixth terminal 336 of the Ethernet PHY 324 may be coupled to the fifth terminal 212C of the CODEC 202C.

In some examples, the first terminal 356 of the time stamp engine 354 is coupled to the MDI 322. The second terminal 358 of the time stamp engine 354 is coupled to the second terminal 376 of the comparator 372 and the first terminal 382 of the clock generator 380. The third terminal 360 of the time stamp engine 354 is coupled to the first terminal 374 of the comparator 372. The third terminal 378 of the comparator 372 is coupled to the second terminal 384 of the clock generator 380. The third terminal 386 of the clock generator 380 is coupled to the first terminal 390 of the clock divider 388. The second terminal 392 of the clock divider 388 is coupled to the fourth terminal 332 of the Ethernet PHY 324. The third terminal 394 of the clock divider 388 is coupled to the fifth terminal 334 of the Ethernet PHY 324. The fourth terminal 396 of the clock divider 388 is coupled to the sixth terminal 336 of the Ethernet PHY 324.

As represented in FIG. 3, the MDI 322 enables communications between the SoC software 308, the SoC hardware 316, and various blocks of the Ethernet PHY 324 (e.g., the MAC interface circuitry 338, the MACsec interface 342, the PCS circuitry 344, the PMA circuitry 348, and the analog drivers 352).

In some examples, the time stamp engine 354 operates to: receive a clock reference packet from the MDI 322 at the first terminal 356; parse a time stamp from the received clock reference packet; and provide a synchronized reference clock signal at the second terminal 358 responsive to the time stamp. The comparator 372 operates to: receive a time stamp at the first terminal 374; receive the synchronized reference clock signal at the second terminal 376; determine a phase offset between the local clock signal and the synchronized wall clock signal; and provide a phase offset indicator at the third terminal 378 responsive to the phase offset. The clock generator 380 operates to: receive the synchronized wall clock signal at the first terminal 382; receive the phase offset indicator at the second terminal 384; and provide an adjusted clock signal at the third terminal 386 responsive to the synchronized wall clock signal and the phase offset indicator. The clock divider 388 operates to: receive the adjusted clock signal at the first terminal 390; provide a first media clock signal (FSYNC) at the second terminal 392 responsive to the adjusted clock signal and a first clock divider setting; provide a second media clock signal (BCLK) at the third terminal 394 responsive to the adjusted clock signal and a second clock divider setting; and provide a third media clock signal (MCLK) at the fourth terminal 396 responsive to the adjusted clock signal and a third clock divider setting.

With the end station circuitry 300, the Ethernet PHY 324 performs expedited clock synchronization operations relative to end station circuitry that relies on MAC operations and software to perform packet parsing as part of clock synchronization operations.

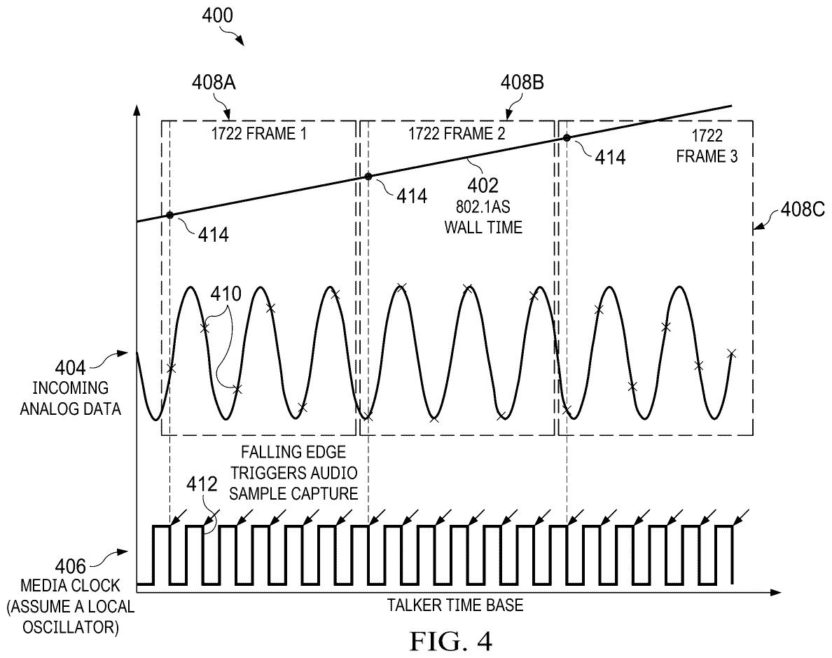

FIG. 4 is a diagram 400 showing example audio data encoding for an end station. In the diagram 400, an 802.1AS wall time 402 accumulates as a constant slope as incoming analog data 404 is received and as a media clock 406 transitions between logical high and low states. At the falling edge 412 of the media clock 406, the analog data 404 is sampled, and the samples 410 are grouped into frames 408A, 408B, and 408C. For the first sample of the samples 410 of the frames 408A, 408B, and 408C, a wall time sample 414 is captured within a threshold time. The wall time samples 414 are used to generate the time stamps described herein. In the example of FIG. 4, the audio encoding is based on IEEE 1722 and the frames 408A, 408B, and 408C may include 16-bit linear pulse modulation data (LPMD) mono audio data. The resulting encoded audio data may be transferred between end stations (e.g., from the “talker” end station 201A to the “listener” end stations 201B and 201C in FIGS. 2A and 2B). The receiving end stations may decode frames of encoded audio data for audio playback operations, road noise cancellation operations, or other operations.

In some control and automation systems, applications and communications are synchronized across network end stations and related subsystems. In such systems, each level of synchronization has its own precision target. In one example, a cloud-based factory uses a wall clock synchronized via global positioning system (GPS). As another example, end stations of a network are synchronized to a working clock for time-triggered frame transmissions. In some examples, end station subsystems and clock sources are synchronized to a common time-base, sometimes referred to as system time. In some examples, an end station supports different time bases. In some examples, an end station supports cross-protocol synchronization using a time-master device. In such examples, the time-master device provides a synchronized master clock to other end stations using different interfaces. Example network interfaces between end stations may include, but are not limited to, a peripheral component interconnect express (PCIe) precision time measurement (PTM) interface and an Ethernet interface (IEEE 1588 or 802.1AS).

In some examples, an end station supports one or more of the following time-bases: a system time; a working clock; and a global time. A system time is the time base between the two end stations, when timestamp values are exchanged. In some examples, the system time can be synchronized via a PTM protocol across a PCIe or Ethernet interface using a PHY clock signal as the system time. The working clock is sometimes referred as the communication time. The working clock is the common time-base for network packet scheduling and traffic management. In some examples, an end station receives 802.1AS PTP streams from its network interface, then PTP streams are decoded and related time stamps are sent to the host for 802.1AS protocol execution. The global time is the time used for time sensitive tasks. In some examples, the global time is received via an Ethernet interface based on the IEEE 802.1AS protocol.

In some examples, an end station relays a global system time by receiving a master time from one interface/protocol and syncing to other end stations to share the global system time. In some examples, an end station tunes on-chip timers and timer managers based on the received global system time. In some examples, an end station supports hardware-based detection of clock differences between a local reference clock and a global system time, allowing processors with internal timers to use adjusted time-bases.

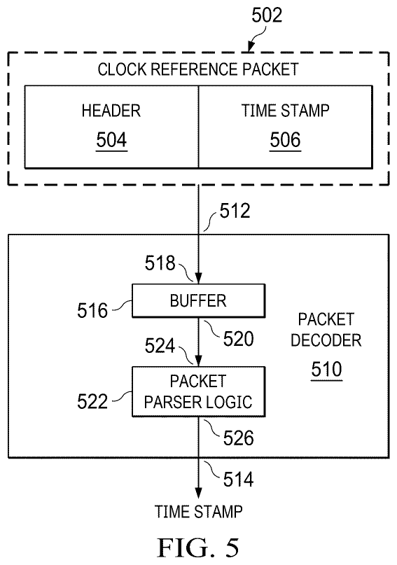

FIG. 5 is a diagram showing an example packet decoder 510. The packet decoder 510 is part of a time stamp engine (e.g., the time stamp engine 354 in FIG. 3) of an Ethernet PHY (e.g., the Ethernet PHY 324 of FIG. 3). As shown, the packet decoder 510 has a first terminal 512 and a second terminal 514. In some examples, the packet decoder 510 includes a buffer 516 and packet parser logic 522. The buffer 516 has a first terminal 518 and a second terminal 520. The packet parser logic 522 has a first terminal 524 and a second terminal 526.

In the example of FIG. 5, the packet decoder 510 receives a packet 502 with a header 504 and a time stamp 506. The packet decoder 510 operates to: receive the packet 502 at the first terminal; store the packet 502 in the buffer 516; parse or otherwise extract the time stamp 506; and provide the time stamp 506 or related information at the second terminal 514. In some examples, the time stamp or related indicator is used by an end station to synchronize its local reference clock and resulting media clocks with a wall time.

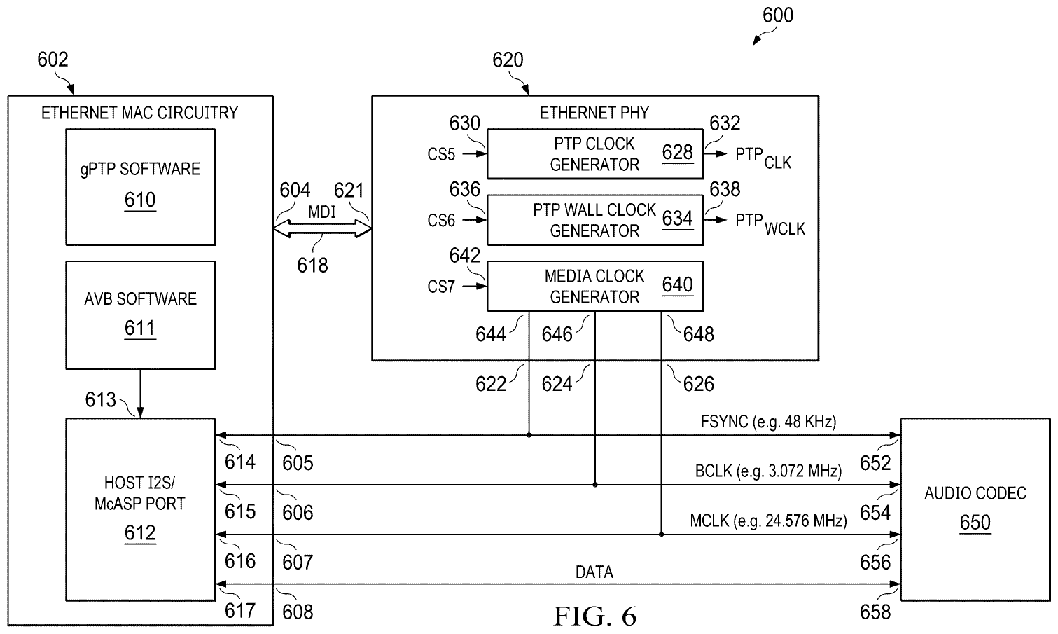

FIG. 6 is a diagram of example end station components 600. The end station components 600 include an Ethernet MAC circuitry 602, an Ethernet PHY 620, and an audio CODEC 650. In some examples, the end station components 600 are included in the end station 201A, the end station 201B, and/or the end station 201C in FIGS. 2A and 2B. In some examples, the Ethernet MAC circuitry 602 is part of an IC (e.g., part of the end station circuitry 214A, end station circuitry 214B, the end station circuitry 214C, or related ICs in FIG. 1). In some examples, the Ethernet MAC circuitry 602 is part of an SoC (e.g., the SoC 302 in FIG. 3). In some examples, the Ethernet PHY 620 is part of an IC (e.g., part of the end station circuitry 214A, the end station circuitry 214B, the end station circuitry 214C, or related ICs in FIG. 1).

In the example of FIG. 6, the Ethernet MAC circuitry 602 has a first terminal 604, a second terminal 605, a third terminal 606, a fourth terminal 607, and fifth terminals 608. The Ethernet PHY 620 has a first terminal 621, a second terminal 622, a third terminal 624, and a fourth terminal 626. The audio CODEC 650 has a first terminal 652, a second terminal 654, a third terminal 656, and fourth terminals 658.

In the example of FIG. 6, the first terminal 604 of the Ethernet MAC circuitry 602 is coupled to the first terminal 621 of the Ethernet PHY 620 via an MDI 618. The second terminal 622 of the Ethernet PHY 620 is coupled to the second terminal 605 of the Ethernet MAC circuitry 602 and the first terminal 652 of the audio CODEC 650. The third terminal 624 of the Ethernet PHY 620 is coupled to the third terminal 606 of the Ethernet MAC circuitry 602 and the second terminal 654 of the audio CODEC 650. The fourth terminal 626 of the Ethernet PHY 620 is coupled to the fourth terminal 607 of the Ethernet MAC circuitry 602 and the third terminal 656 of the audio CODEC 650. The fourth terminal 658 of the audio CODEC 650 is coupled to the fifth terminal 608 of the Ethernet MAC circuitry 602.

In the example of FIG. 6, the Ethernet MAC circuitry 602 includes gPTP software 610, AVB software 611, and a host inter-IC source/multi-channel audio serial port (12S/McASP) 612. In some examples, the gPTP software 610, the AVB software 611, and the host 12S/McASP 612 is part of an SoC (e.g., the SoC 302 in FIG. 3). In the example of FIG. 6, the host 12S/McASP 612 has a first terminal 613, a second terminal 614, a third terminal 615, a fourth terminal 616, and a fifth terminal 617.

The PHY 620 has a PTP clock generator 628, a PTP wall clock generator 634, and a media clock generator 640. The PTP clock generator 628 has first terminals 630 and a second terminal 632. The PTP wall clock generation 634 has first terminal 636 and a second terminal 638. The media clock generator 640 has first terminals 642, a second terminal 644, a third terminal 646, and a fourth terminal 648.

In the example of FIG. 6, the first terminal 613 of the host 12S/McASP 612 receives information from the AVB software 611. The second terminal 614 of the host 12S/McASP 612 is coupled to the second terminal 605 of the Ethernet MAC circuitry 602. The third terminal 615 of the host 12S/McASP 612 is coupled to the third terminal 606 of the Ethernet MAC circuitry 602. The fourth terminal 616 of the host 12S/McASP 612 is coupled to the fourth terminal 607 of the Ethernet MAC circuitry 602. The fifth terminal 617 of the host 12S/McASP 612 is coupled to the fifth terminal 608 of the Ethernet MAC circuitry 602.

In the example of FIG. 6, the second terminal 644 of the media clock generator 640 is coupled to the second terminal 622 of the Ethernet PHY 620. The third terminal 646 of the media clock generator 640 is coupled to the third terminal 624 of the Ethernet PHY 620. The fourth terminal 648 of the media clock generator 640 is coupled to the fourth terminal 626 of the Ethernet PHY 620.

In the example of FIG. 6, the Ethernet MAC circuitry 602 operates to: perform gPTP operations using the gPTP software 610; perform AVB operations using the AVB software 611; and transfer data using the host 12S/McASP 612. In some examples, the gPTP operations include: using a clock servo algorithm to correct offset and rate of PTP_{CLK}; and mirroring PTP_{WCLK} from the Ethernet PHY to the host. In some examples, mirroring of PTP_{WCLK} uses general programmable input/output (GPIO) timestamping. In some examples, the AVB operations include: media stream data packet decode; media clock configuration and management; media flow management (e.g., stream FIFO overflow/underflow); and stream playback epoch synchronization.

The Ethernet PHY 620 operates to: generate a PTP clock signal (PTP_{CLK} herein) using the PTP clock generator 628; generate a PTP wall clock signal (PTP_{WCLK} herein) using the PTP wall clock generator 634; and generate media clocks using the media clock generator 640. More specifically, the PTP clock generator 628 operates to: receive control settings CS5 at the first terminals 630; and provide PTP_{CLK} at the second terminal 632 responsive to the control settings. In some examples, PTP_{CLK} is a high-frequency clock signal that is divided to generate media clocks.

The PTP wall clock generator 634 operates to: receive control settings CS6 at the first terminals 636; and provide PTP_{WCLK} at the second terminal 638 responsive to the control settings CS6. PTP_{WCLK} is used to generate time stamps as described herein.

The media clock generator 640 operates to: receive control settings CS7 at the first terminals 642; provide a first media clock signal (e.g., FSYNC) at the second terminal 644 responsive to the control settings CS7; provide a second media clock signal (e.g., BCLK) at the third terminal 646 responsive to the control settings CS7; and provide a third media clock signal (e.g., MCLK) at the fourth terminal 648 responsive to the control settings CS7. In some examples, the media clock signals are used to encode or decode audio data.

The audio CODEC 650 operates to: receive the first media clock signal at the first terminal 652; receive the second media clock signal at the second terminal 654; receive the third media clock signal at the third terminal 656; decode audio data received by at least some of the fourth terminals 658; and encode audio data for transmission by at least some of the fourth terminals 658.

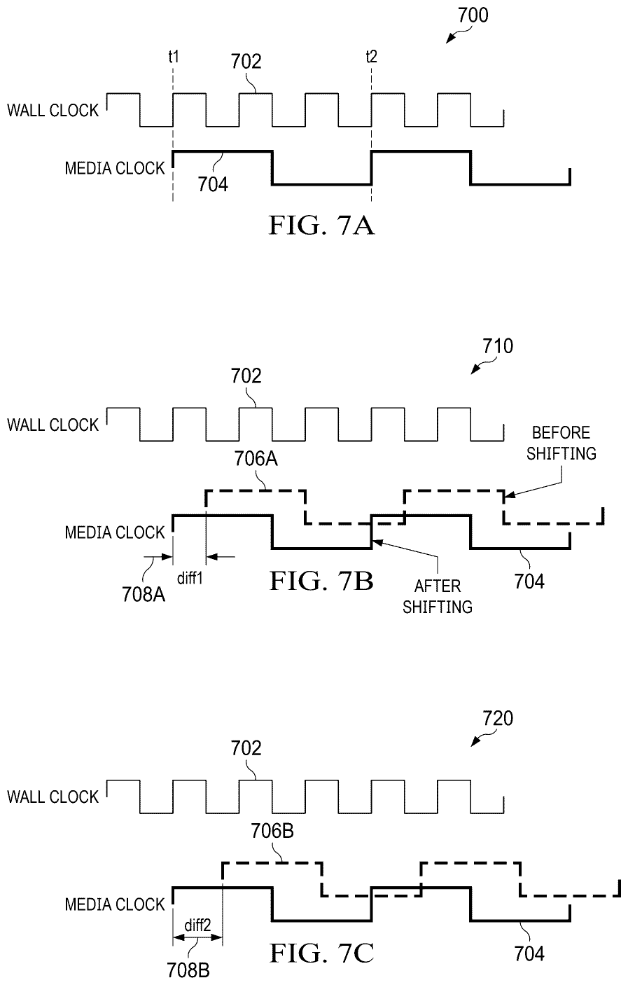

FIGS. 7A to 7C are timing diagrams 700, 710, and 720 showing example clock synchronization. In the timing diagram 700, a wall clock signal 702 and a media clock signal 704 have aligned edges. Over time, the phase of the media clock signal 704 may drift, resulting in a misaligned media clock signal 706A or 706B as in FIGS. 7B and 7C. In the example of FIG. 7B, the misaligned media clock signal 706A has a first phase offset (diff1) 708A. In the example of FIG. 7C, the misaligned media clock signal 706B has a second phase offset (diff2) 708B, where diff2 is greater than diff1.

In the described examples, phase offset detection between a wall clock signal (e.g., the wall clock signal 702), or related time stamps, and a media clock signal (e.g., the media clock signal 704, the misaligned media clock signal 706A, or the misaligned media clock signal 706B) is performed. Such phase offsets (e.g., diff1, diff2, etc.) are used as a control input to a media clock generator to adjust the media clock signal periodically to maintain the phase offset within a target synchronization tolerance.

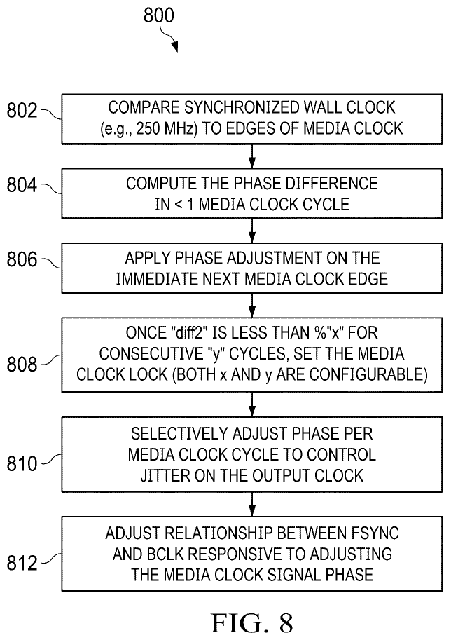

FIG. 8 is a flowchart showing an example clock synchronization method 800. In some examples, the clock synchronization method 800 is performed by an IC (e.g., one of the end station circuitries 214A, 214B, or 214C or related ICs in FIGS. 2A and 2B) or a related Ethernet PHY (e.g., the Ethernet PHY 324 in FIG. 3). In the example of FIG. 8, the clock synchronization method 800 compares a synchronized wall clock signal (e.g., at 250 MHz) to edges of a media clock signal at block 802. At block 804, the phase offset or phase difference is computed within 1 media clock cycle. At block 806, a phase adjustment is applied on the immediate next media clock signal edge. At block 808, once the phase offset (e.g., diff2) is less than a target offset (% x) for a number of consecutive cycles (y), a media clock signal lock is set. In different examples, the values of x and y may vary. At block 810, the phase per media clock cycle is selectively adjusted to control jitter on an output clock (e.g., FSYNC, BCLK, or MCLK herein). At block 812, the relationship between media clocks (e.g., FSYNC and BCLK) are adjusted as needed.

In some examples, media clocks are based on free-running local oscillators when the media clocks do not need to lock to any reference (as long as all media clocks in the same domain are frequency-synchronized). In some examples, a media clock signal is periodically used by a local timestamp generator to generate timestamps (e.g., every target number of clock rising edges). In some examples, timestamps are generated based off of a local reference clock signal. A wall clock then translates the local timestamps to generalized precision time control (gPTP) timestamps. As needed, an end station adds a fixed offset and generates presentation timestamps. The presentation time represents the gPTP time at which a designated media sample or event transfers to the time-sensitive application within each listener end station. This enables multiple listener end stations to present data at the same time, regardless of their location in the network. The talker end station tells a listener end station when to start processing (that is, playing) the stream's data, and is also used to recover the stream's media clock.

In some examples, a listener end station decodes presentation timestamps from clock reference packets and recovers the source media clock from the incoming stream generated by a talker end station. The time difference between two presentation timestamps divided by the number of samples in between provides an estimate of the source media clock in the gPTP time base. Continually performing this calculation and applying appropriate filtering techniques yields an accurate measurement of the source's media clock period.

In some examples, a media clock generator's output is timestamped with a local time base that is then translated to a gPTP time base in order to accurately measure its period. After comparing the two clock periods, a media clock recovery module continually generates commands to incrementally increase or decrease the output frequency of the clock generator, thus synchronizing the local media clock to the source media clock.

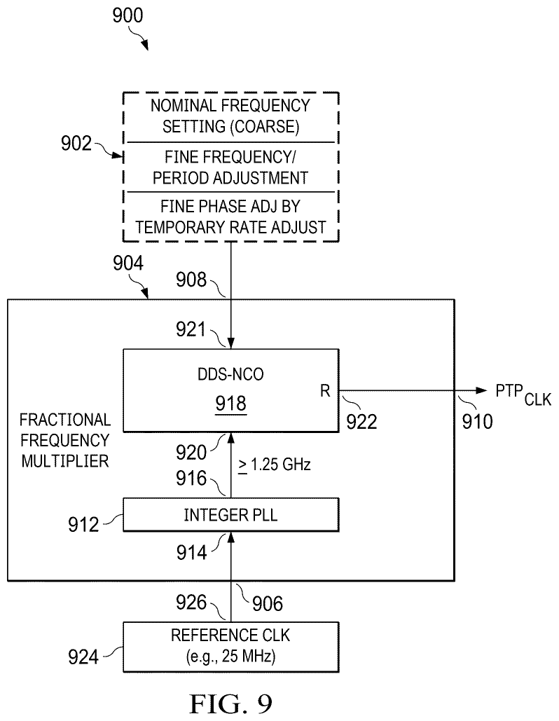

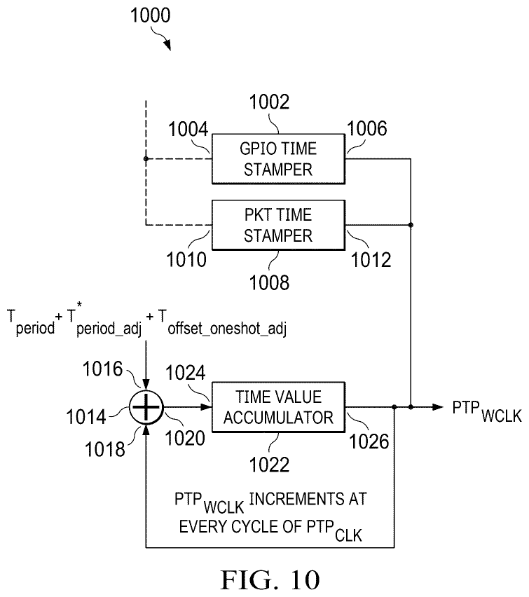

FIGS. 9 and 10 are diagrams showing example PHY components 900 and 1000.

In some examples, the PHY components 900 and 1000 are part of an Ethernet PHY (e.g., the Ethernet PHY 324 in FIG. 3). In some examples, the Ethernet PHY is part of end station circuitry (e.g., the end station circuitry 214A, the end station circuitry 214B, or the end station circuitry 214C in FIGS. 2A and 2B). The PHY components 900 and 1000 further clarify Ethernet PHY features or options related to time stamp decoding, local reference clock synchronization, and/or media clock signal generation. In the example of FIG. 9, the PHY components 900 include a fractional frequency multiplier 904 and a reference clock source 924. The reference clock source 924 has a terminal 926. The fractional frequency multiplier 904 has a first terminal 906, a second terminal 908, and a third terminal 910. The fractional frequency multiplier 904 includes an integer phase locked-loop (PLL) 912 and a direct digital synthesis numerically-controlled oscillator (DDS-NCO) 918. The integer PLL 912 has a first terminal 914 and a second terminal 916. The DDS-NCO 918 has a first terminal 920, a second terminal 921, and a third terminal 922.

The first terminal 906 of the fractional frequency multiplier 904 is coupled to the terminal 926 of the reference clock source 924 and the first terminal 914 of the integer PLL 912. The second terminal 916 of the integer PLL 912 is coupled to the first terminal 920 of the DDS-NCO 918. The second terminal 908 of the fractional frequency multiplier 904 is coupled to the second terminal 921 of the DDS-NCO and receives configuration settings 902. In some examples, the configuration settings 902 include a nominal or course frequency setting, a fine frequency/period adjustment setting, and a fine phase adjustment setting (e.g., by temporary rate adjustment). The third terminal 922 of the DDS-NCO 918 is coupled to the third terminal 910 of the fractional frequency multiplier 904 and provides a PTP clock (PTP_{CLK}).

In the example of FIG. 9, the fractional frequency multiplier 904 operates to: receive a reference clock signal at the first terminal 906; receive the configuration settings 902 at the second terminal 908; and provide PTP_{CLK} at the third terminal 910 responsive to the reference clock signal and the configuration settings. More specifically, the integer PLL 912 operates to: receive the reference clock signal at the first terminal 914; and provide a PLL output clock signal at the second terminal 914 based on the reference claim signal and a multiplier. In some examples, the reference clock signal has a frequency of 25 MHz and the PLL output clock signal has a frequency equal to or greater than 1.25 GHz. The DDS-NCO 918 operates to: receive the PLL output clock signal at the first terminal 920; receive the configuration settings 902 at the second terminal 921; and provide PTP_{CLK} at the third terminal 922 responsive to the PLL output clock signal and the configuration settings 902. In some examples, PTP_{CLK} is provided to a divider to generate media clocks (e.g., FSYNC, BCLK, and MCLK) that are edge aligned with PTP_{CLK}.

In the example of FIG. 10, the PHY components 1000 include a general programmable input/output (GPIO) time stamper 1002, a packet time stamper 1008, a summation circuit 1014, and a time value accumulator 1022. The GPIO time stamper 1002 has a first terminal 1004 and a second terminal 1006. The packet time stamper 1008 has a first terminal 1010 and a second terminal 1012. The summation circuit 1014 has a first terminal 1016, a second terminal 1018, and a third terminal 1020. The time value accumulator 1022 has a first terminal 1024 and a second terminal 1026.

In some examples, the first terminal 1004 of the GPIO time stamper 1002 and the first terminal 1010 of the packet time stamper 1008 receive a mirrored PTP wall clock (e.g., PTP_{WCLK}) from gPTP software (e.g., the gPTP software 610 in FIG. 6). In some examples, communications between an Ethernet MAC and an Ethernet PHY are host-PHY communications via MDIO (also known as serial management interface or “SMI”) reads/writes and interrupts. In some examples, communications via MDIO are based on MDIO clock (MDC). In some examples, the GPIO time stamper 1002 operates to: receive a mirrored PTP_{WCLK} at the first terminal 1004; and provide a first time stamp at the second terminal 1006 based on the mirrored PTP_{WCLK}. The packet time stamper 1008 operates to: receive the mirrored PTP_{WCLK} at the first terminal 1010; and provide a second time stamp at the second terminal 1012 based on the mirrored PTP_{WCLK}. The summation circuit 1014 operates to: receive a period adjustment value at the first terminal 1016; receive a wall clock incremental value at the second terminal 1018; and provide a summed value at the third terminal 1020 responsive the period adjustment value and the wall clock incremental value. In some examples, the time value accumulator operates to: receive the summed value at the first terminal 1024; and provide PTP_{WCLK} at the second terminal 1026 responsive to the summed value.

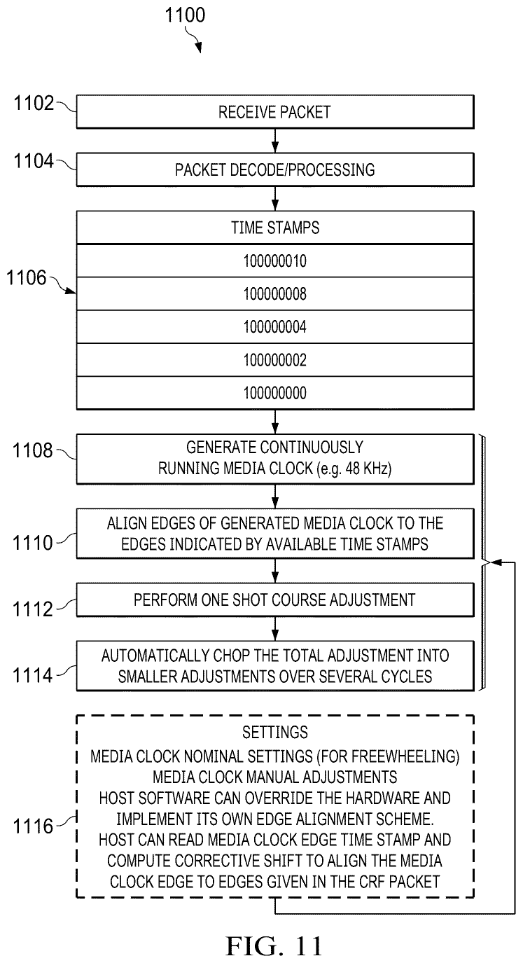

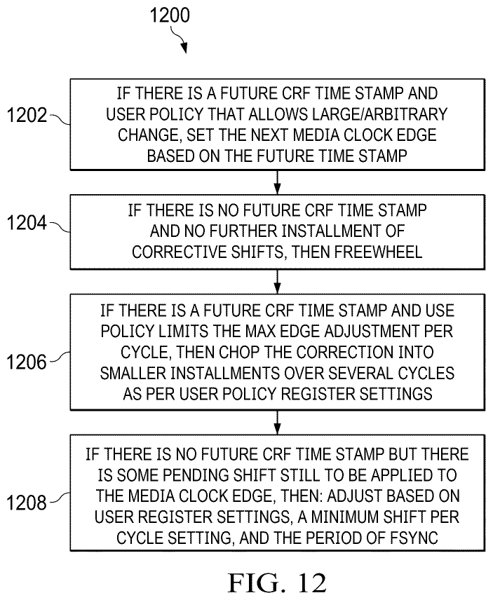

FIGS. 11 and 12 are flowcharts showing example PHY methods 1100 and 1200. In some examples, the PHY methods 1100 and 1200 are performed by the end station circuitry 100 of FIG. 1, the end station circuitry 214A of FIG. 2A, the end station circuitry 214B of FIG. 2A, the end station circuitry 214C of FIG. 2B, the Ethernet PHY 324 of FIG. 3, the Ethernet PHY 620 of FIG. 6. In the example of FIG. 11, the PHY method 1100 includes receiving a packet (e.g., a clock reference packet or “CRF” packet) at block 1102. At block 1104, packet decode/processing is performed, results in time stamps 1106. At block 1108, a continuously running media clock (e.g., 48 KHz) is generated. At block 1110, the edges of the media clock are aligned to the edges indicated by available time stamps (e.g., the time stamps 1106). At block 1112, one shot course adjustment is performed. At block 1114, the total adjustment is chopped into smaller adjustments over several cycles. For the PHY method 1100, various settings 1116 may be used including: media clock nominal settings (for freewheeling); media clock manual adjustments; host software can override the hardware and implement its own edge alignment scheme; host can read media clock edge time stamp and compute corrective shift to align the media clock edge to edges given in the CRF packet. In some examples, the corrective shift is given as:

dTcorrective_{shift}=(T_{edge_crf}−T_{edge_fsync})modulo T_{period_fsync}. Equation (1)

In some examples, CRF time stamps are expected to monotonically increment from one CRF packet to the next. In such examples, FIFO registers are used to store ordered future time stamps. In the example of FIG. 12, the PHY method 1200 includes setting T_{threshold_next}=T_{orfnext} if there is a future CRF time stamp and user policy to allow large/arbitrary change at block 1202. This will be the case, for example, when restarting the media clock. At block 1204, freewheeling is performed if there is no future CRF time stamp and no further installment of corrective shift. In some examples, a freewheeling clock is generated using default extrapolation. In such examples, T_{threshold_next}=T_{threshold}+T_{tsync}. At block 1206, the correction is chopped into smaller installments over several cycles as per user policy register settings if there is a future CRF time stamp and use policy limits the maximum edge adjustment per cycle. At block 1208, corrections are performed based on user register settings, a minimum shift per cycle setting, and the period of FSYNC if there is no future CRF time stamp but there is some pending shift still to be applied to the media clock edge.

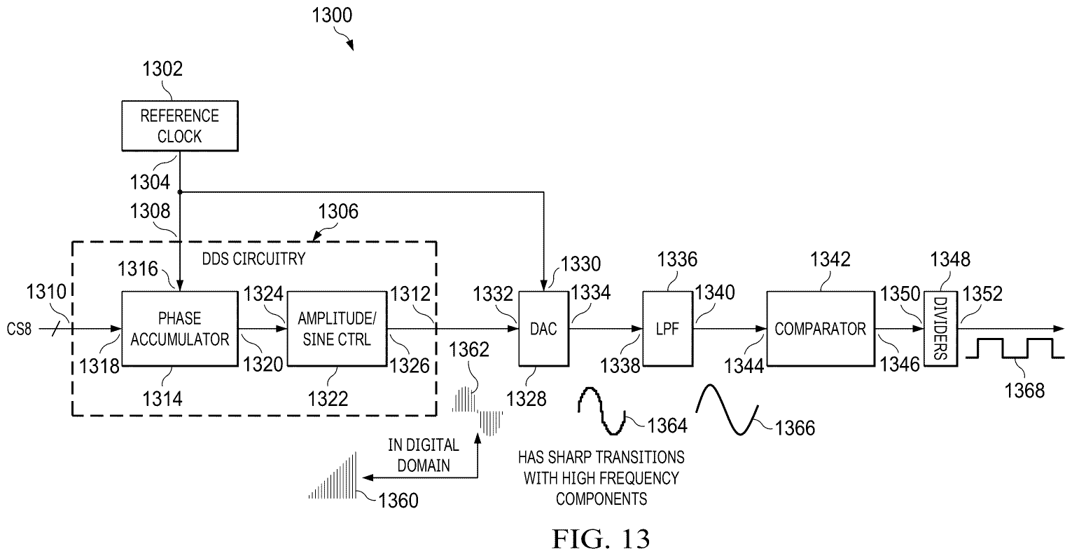

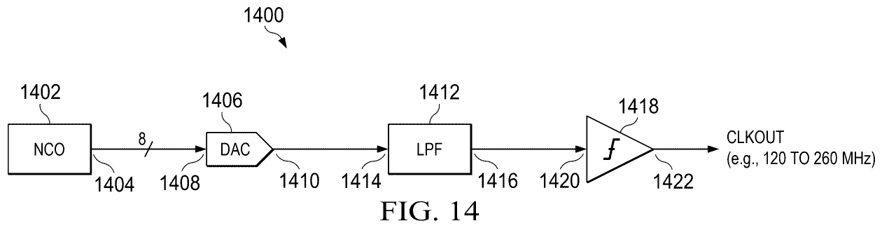

FIGS. 13 and 14 are diagrams showing example clock generators 1300 and 1400. The clock generators 1300 and 1400 are examples of the media clock generator 138 in FIG. 1, or part of the clock generator circuitry 237A, 237B, or 237C in FIGS. 2A and 2B. In some examples, the clock generators 1300 and 1400 are used to generate media clocks from a reference clock signal and a phase offset adjustment. In FIG. 13, the clock generator 1300 includes a reference clock source 1302, DDS circuitry 1306, a digital-to-analog converter (DAC) 1328, a low-pass filter (LPF) 1336, a comparator 1342, and divider circuitry 1348. FIG. 13 also shows example results 1360, 1362, 1364, 1366, and 1368 for the various components of the clock generator 1300. In some examples, media clocks are generated for use by a CODEC as described herein. In other examples, media clocks are used in an industrial application (e.g., a factory) for synchronized operation of actuators or other time-sensitive applications.

The reference clock source 1302 has a terminal 1304. The DDS circuitry 1306 has a first terminal 1308, a second terminal 1310, and a third terminal 1312. The DDS circuitry 1306 includes a phase accumulator 1314 and an amplitude/sine controller 1322. The phase accumulator 1314 has a first terminal 1316, a second terminal 1318, and a third terminal 1320. The amplitude/sine controller 1322 has a first terminal 1324 and a second terminal 1326. The DAC 1328 has a first terminal 1330, a second terminal 1332, and a third terminal 1334. The LPF 1336 has a first terminal 1338 and a second terminal 1340. The comparator 1342 has a first terminal 1344 and a second terminal 1346. The divider circuitry 1348 has a first terminal 1350 and a second terminal 1352.

In the example of FIG. 13, the terminal 1304 of the reference clock source 1302 is coupled to the first terminal 1308 of the DDS circuitry 1306 and the first terminal 1330 of the DAC 1328. The second terminal 1310 of the DDS circuitry 1306 is coupled to the first terminal 1316 of the phase accumulator 1314 and receives a control setting CS8. In some examples, the control setting CS8 is a digital control signal (a tuning word) that specifies a target output frequency as a fraction of the frequency of the reference clock signal. The third terminal 1320 of the phase accumulator 1314 is coupled to the first terminal 1324 of the amplitude/sine controller 1322. The second terminal 1326 of the amplitude/sine controller 1322 is coupled to the third terminal 1312 of the DDS circuitry 1306 and the second terminal 1332 of the DAC 1328. The third terminal 1334 of the DAC 1328 is coupled to the first terminal 1338 of the LPF 1336. The second terminal 1340 of the LPF 1336 is coupled to the first terminal 1344 of the comparator 1342. The second terminal 1346 of the comparator 1342 is coupled to the first terminal 1350 of the divider circuitry 1348. The second terminal 1352 of the divider circuitry 1348 provides a media clock.

The reference clock source 1302 operates to provide a reference clock signal at the terminal 1304. The DDS circuitry 1306 operates to: receive the reference clock signal at the first terminal 1308; receive the control setting CS8 at the second terminal 1310; and provide a digitized sinusoidal signal at the third terminal 1312 responsive to the reference clock signal, the control setting CS8, the operations of the phase accumulator 1314, and the operations of the amplitude/sine controller 1322. More specifically, the phase accumulator 1314 operates to: receive the reference clock signal at the first terminal 1316; receive the control setting CS8 at the second terminal 1318; and provide result 1360 (a digitized accumulation signal) responsive to the reference clock signal and the control setting CS8. The amplitude/sine controller 1322 operates to: receive the result 1360 at the first terminal 1324; and provide result 1362 at the second terminal 1326 responsive to the result 1360 and control settings of the amplitude/sine controller 1322. In some examples, the amplitude/sine controller 1322 converts the amplitude of the result 1360 from the phase accumulator 1314 into a digitized sinusoidal signal having phase, frequency, or amplitude based on the result 1360.

The DAC 1328 operates to: receive the reference clock signal at the first terminal 1330; receive the result 1362 from the DDS circuitry 1306 at the second terminal 1332; and provide result 1364 at the third terminal 1334 responsive to the reference clock signal and the result 1362. In some examples, the result 1364 is an analog version of the result 1362, where the result 1364 has sharp transitions and high frequency components. The LPF 1336 operates to: receive the result 1364 at the first terminal 1338; and provide result 1366 at the second terminal 1340 responsive to the result 1364 and filtering operations of the LPF. The result 1366 from the LPF 1336 is smoothed version of the result 1364 from the DAC 1328.

The comparator 1342 operates to: receive the result 1366 at the first terminal 1344; compare the result 1366 with one or more thresholds; and provide comparison results at the second terminal 1346 responsive to the result 1366 and the one or more thresholds.

The divider circuitry 1348 operates to: receive the comparison results at the first terminal 1350; and provide result 1368 at the second terminal 1352 responsive to the comparison results and a divider setting of the divider circuitry 1348. In some examples, the result 1368 is a square wave used as a media clock. In some examples, the divider circuitry 1348 has multiple divider settings and provides multiple results, each result having a different frequency.

In FIG. 14, the clock generator 1400 includes an NCO 1402, a DAC 1406, an LPF 1412, and a slicer 1418. The NCO 1402 is an example of the DDS circuitry 1306 in FIG. 13. The DAC 1406 is an example of the DAC 1328 in FIG. 13. The LPF 1412 is an example of the LPF 1336 in FIG. 13. The slicer 1418 is an example of the comparator 1342 in FIG. 13. In the example of FIG. 14, the NCO 1402 has a terminal 1404. The DAC has a first terminal 1408 and a second terminal 1410. The LPF 1412 has a first terminal 1414 and a second terminal 1416. The slicer 1418 has a first terminal 1420 and a second terminal 1422.

The terminal 1404 of the NCO 1402 is coupled to the first terminal 1408 of the DAC 1406. The second terminal 1410 of the DAC 1406 is coupled to the first terminal 1414 of the LPF 1412. The second terminal 1416 of the LPF 1412 is coupled to the first terminal 1420 of the slicer 1418. The second terminal 1422 of the slicer 1418 provides an output clock CLKOUT. CLKOUT may be a media clock or may be divided to generate media clocks as described herein. In some examples, the frequency CLKOUT is adjustable (e.g., between 120 MHz to 260 MHZ).

The NCO 1402 operates to provide a digitized sinusoidal signal at the terminal 1404. The DAC 1406 operates to: receive the digitized sinusoidal signal at the first terminal 1408; and provide an analog sinusoidal signal at the second terminal 1410 based on the digitized sinusoidal signal. The LPF 1412 operates to: receive the analog sinusoidal signal at the first terminal 1414; and provide a smoothed analog sinusoidal signal at the second terminal 1416. The slicer 1418 operates to: receive the smoothed analog sinusoidal signal at the first terminal 1420; and provide a square wave signal at the second terminal 1422 based on the smoothed analog sinusoidal signal and thresholds of the slicer 1418.

In some examples, an end station includes a time stamp engine (for extraction/insertion of time stamps) based on IEEE 1588 and a media clock generator based on IEEE 1722 CRF as described in the example of FIGS. 2A and 2B. In some examples, the time stamp engine and the media clock generator are part of an Ethernet PHY to be close to the Ethernet cable and to minimize timestamp errors due to latency uncertainties in traffic.

In some examples, an open loop, NCO-based DDS (e.g., the fractional frequency multiplier 904 in FIG. 9) generates the PTP clock. The NCO is fed by a high frequency clock (e.g., 1.25 GHZ) and produces a widely tunable output frequency that is lower by around 5× to 10× (e.g., 120 MHz to 260 MHz). In some examples, an integer PLL (e.g., the integer PLL 912 in FIG. 9) is used to first multiply a local reference clock signal (e.g., from the reference clock source 924 in FIG. 9) and provide a faster clock to the NCO. In some examples, the local reference clock signal is a 25 MHz signal provided by a crystal oscillator (XTAL) or a temperature-compensation crystal oscillator (TCXO). The integer PLL provides a 1.25 GHz (or faster) clock to the NCO. The NCO-DDS constructs a pseudo sine wave of continuously configurable frequency (e.g., between 120 MHz to 260 MHz). The pseudo sine wave undergoes low-pass filtering and the filtered result is fed to a comparator to produce a square wave of the same fundamental frequency. This is then used as the PTP clock for the entire 1588/1722 logic (tunable in range 120 MHz-260 MHz).

In some examples, the NCO is fractionally fine-tunable continuously on the fly by software. In some examples, a PTP clock correction servo algorithm (e.g., provided by the amplitude/sine controller 1322 in FIG. 13) uses the NCO output to correct rate error (i.e., time interval error) due to the reference clock signal having a parts-per-million (ppm) error. Small adjustments produce negligible jitter. In some examples, the NCO is register configurable initially by software over an MDIO or serial management interface (SMI) interface between the PHY and the SoC host. This initial configuration for the NCO sets the nominal frequency plan for the application.

For audio applications, the NCO can be configured to a nominal PTP frequency that is an integer multiple of target audio clock frequency (FSYNC). In some examples, FSYNC is set to 48.00000 KHz or 44.100000 KHz. The remaining ppm error due to the local reference clock can subsequently be corrected by the IEEE 1588 PTP clock servo algorithm (implemented in host and that accesses the NCO over MDIO).

In some examples, the PTP wall clock described herein is a numeric time value accumulator (or calendar) with sub-nS resolution. In such examples, the time-value of the NCO driven PTP wall clock is compared to time stamps for target edge times to directly produce media clocks (e.g., FSYNC,BCLK) without any additional edge jitter, while maintaining accurate alignment.

In some examples, CRF packet parser logic extracts CRF timestamps from an ingress IEEE 1722 packet stream. These time stamps define the target edges of the media clock (as per global PTP clock). In some examples, different media clocks are generated. In some examples: FSYNC has a frequency of 48 KHz, 44.1 KHz, or 8 KHz; BCLK has a frequency of 64*FSYNC; and the CODEC clock has a frequency of BCLK*8. Such media clocks are generated, for example, by dividers that automatically maintain edge alignment with the recovered CRF timestamps. As needed, large misalignments are automatically addressed by the PHY hardware over many cycles in small steps. In some scenarios, CRF packets in a network are sparsely exchanged. In between reception of CRF packets, PHY hardware automatically computes the next edges of the media clocks based on their nominal period and the local PTP synchronized wall clock.

In some examples, end stations perform clock synchronization and media clock generation using co-located hardware (e.g., PHY hardware) to perform IEEE 1588 time stamping and IEEE 1722 media clock recovery. In some examples, a tunable NCO is used as the PTP clock source, which allows the PTP clock to be an integer multiple of an audio clock. This allows direct generation of media clocks from PTP time stamps. In some examples, CRF packet decode is integrated into a hardware state machine to extract and extrapolate CRF edges and generate fully synchronized media clock signals from the PHY. In some examples, use of a fractional PLL to generate media clocks is avoided. Also, no additional frequency correction software is needed for media clock generation, which simplifies synchronization and media clock generation. In some examples, clock synchronization and media clock generation hardware automates edge alignment and reduces software overhead. In some examples, the described hardware reduces the settling time for the recovered media clock. While applicable to audio over Ethernet, the described hardware for clock synchronization and media clock generation may also be applied to other audio standards such as Dante, AES67, sensor data time stamping for sensor fusion application, or other applications.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal”, “node”, “interconnection”, “pin” and “lead” are used interchangeably. Unless specifically stated to the contrary, these terms are generally used to mean an interconnection between or a terminus of a device element, a circuit element, an integrated circuit, a device or other electronics or semiconductor component and/or a conductor.

A circuit or device described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field-effect transistor (“FET”) such as an NFET or a PFET, a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control terminal and its first and second terminals. In the context of a FET, the control terminal is the gate, and the first and second terminals are the drain and source. In the context of a BJT, the control terminal is the base, and the first and second terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated circuit. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described examples, and other examples are possible, within the scope of the claims.

1. An apparatus comprising:
packet decoder circuitry having a first terminal and a second terminal;
a reference clock generator having a first terminal and a second terminal, the first terminal of the reference clock generator coupled to the second terminal of the packet decoder circuitry;
control circuitry having a first terminal, a second terminal, a third terminal, and a fourth terminal, the first terminal of the control circuitry coupled to the second terminal of the packet decoder circuitry, the second terminal of the control circuitry coupled to the first terminal of the reference clock generator, the third terminal of the control circuitry coupled to the second terminal of the reference clock generator; and
a media clock generator having a first terminal and a second terminal, the first terminal of the media clock generator coupled to the second terminal of the reference clock generator, and the second terminal of the media clock generator coupled to the fourth terminal of the control circuitry.

2. The apparatus of claim 1, wherein the packet decoder circuitry is configured to:
receive a clock reference packet at the first terminal of the packet decoder circuitry;
decode a time stamp from the clock reference packet; and
provide the time stamp at the second terminal of the packet decoder circuitry, the control circuitry is configured to:
receive the time stamp at the first terminal of the control circuitry;
provide first frequency/phase control settings at the second terminal responsive to the time stamp; and
provide second frequency/phase control settings at the third terminal responsive to the time stamp.

3. The apparatus of claim 2, wherein the reference clock generator is configured to:
receive the phase control setting at the first terminal of the reference clock generator; and
provide a reference clock signal at the second terminal responsive to the first frequency/phase control settings; and
the media clock generator is configured to:
receive the reference clock signal at the first terminal;
receive the second frequency/phase control settings at the second terminal; and
generate a media clock signal responsive to the reference clock signal and the second frequency/phase control settings.

4. The apparatus of claim 1, further comprising coder/decoder (CODEC) circuitry having a first terminal, a second terminal, and a third terminal, the first terminal of the CODEC circuitry coupled to the third terminal of the media clock generator, and the CODEC circuitry configured to:
receive the media clock signal at the first terminal of the CODEC circuitry;
receive a media steam at the second terminal of the CODEC circuitry; and
decode the media stream based on the media clock.

5. The apparatus of claim 4, wherein the packet decoder circuitry, the reference clock generator, the control circuitry, and the media clock generator are components of Ethernet physical (PHY) circuitry.

6. The apparatus of claim 5, wherein the media stream is an Ethernet audio data stream.

7. The apparatus of claim 5, wherein further comprising a memory and processor coupled to the memory and the Ethernet PHY circuitry, the memory storing Ethernet media access (MAC) instructions and MAC interface instructions for execution by the processor.

8. The apparatus of claim 1, wherein the packet decoder circuitry includes packet parser logic.

9. The apparatus of claim 1, wherein the media clock generator includes:
numerically-controlled oscillator (NCO) circuitry; and
a digital-to-analog converter (DAC) coupled to the NCO circuitry.

10. Ethernet physical (PHY) circuitry comprising:
packet decoder circuitry having a first terminal and a second terminal;
a reference clock generator having a first terminal and a second terminal, the first terminal of the reference clock generator coupled to the second terminal of the packet decoder circuitry;
control circuitry having a first terminal, a second terminal, a third terminal, and a fourth terminal, the first terminal of the control circuitry coupled to the second terminal of the packet decoder circuitry, the second terminal of the control circuitry coupled to the first terminal of the reference clock generator, the third terminal of the control circuitry coupled to the second terminal the reference clock generator; and
a media clock generator having a first terminal and a second terminal, the first terminal of the media clock generator coupled to the second terminal of the reference clock generator, and the second terminal of the media clock generator coupled to the fourth terminal of the control circuitry.

11. The Ethernet PHY circuitry of claim 10, wherein the packet decoder circuitry is configured to:
receive a clock reference packet at the first terminal of the packet decoder circuitry;
decode a time stamp from the clock reference packet; and
provide the time stamp at the second terminal of the packet decoder circuitry, the control circuitry is configured to:
receive the time stamp at the first terminal of the control circuitry;
provide first frequency/phase control settings at the second terminal responsive to the time stamp; and
provide second frequency/phase control settings at the third terminal responsive to the time stamp.

12. The Ethernet PHY circuitry of claim 11, wherein the reference clock generator is configured to:
receive the phase control setting at the first terminal of the reference clock generator; and
provide a reference clock signal at the second terminal responsive to the first frequency/phase control settings; and
the media clock generator is configured to:
receive the reference clock signal at the first terminal;
receive the second frequency/phase control settings at the second terminal; and
generate a media clock signal responsive to the reference clock signal and the second frequency/phase control settings.

13. The Ethernet PHY circuitry of claim 10, wherein the packet decoder circuitry includes packet parser logic.

14. The Ethernet PHY circuitry of claim 10, wherein the media clock generator includes:
numerically-controlled oscillator (NCO) circuitry; and
a digital-to-analog converter (DAC) coupled to the NCO circuitry.

15. The Ethernet PHY circuitry of claim 14, wherein the media clock generator includes direct digital synthesis (DDS) circuitry.

16. A method comprising:
receiving, by Ethernet physical (PHY), a clock reference packet;
decoding, by the Ethernet PHY, a time stamp from the clock reference packet;
adjusting, by the Ethernet PHY, a reference clock signal based on the time stamp; and
generating, by the Ethernet PHY, a media clock based on the adjusted reference clock.

17. The method of claim 16, further comprising
receiving, by the Ethernet PHY, a subsequent clock reference packet;
decoding, by the Ethernet PHY, a subsequent time stamp from the subsequent clock reference packet;
adjusting, by the Ethernet PHY, the reference clock signal based on the subsequent time stamp; and
generating, by the Ethernet PHY, a media clock based on the adjusted reference clock signal.

18. The method of claim 16, further comprising decoding the time stamp using packet parser logic.

19. The method of claim 16, further comprising:
receiving, by a coder/decoder (CODEC), media data;
receiving, by the CODEC, a media clock signal; and
provide a media stream responsive to the media data and the media clock.

20. The method of claim 16, further comprising generating the media clock using numerically-controlled oscillator (NCO) circuitry.
